(19) United States
(12) Patent Application Publication
(10) Pub. No.: US 2012/0258735 A1
(43) Pub. Date: Oct. 11, 2012

(54) SOCIAL NETWORK GEOGRAPHIC FILTER

(76) Inventor: Dante Monteverde, Las Vegas, NV (US)

(21) Appl. No.: 13/403,350

(22) Filed: Feb. 23, 2012

Related U.S. Application Data
(63) Continuation-in-part of application No. 13/082,008, filed on Apr. 7, 2011.

(51) Int. Cl. H04W 4/02

(52) U.S. Cl. 455/456.3

(57) ABSTRACT

A method and system for defining a geographic target area for filtering communications or messages based on geographic criteria. The target area can relate to the user's common shopping area or a maximum distance he or she is willing to travel for a given event or a given time. A trip planner is also disclosed that allows a user to specify a planned trip and that alerts other users along a path of the trip.

### CROSS REFERENCE TO RELATED APPLICATION

The present application is a continuation-in-part of U.S. patent application Ser. No. 13/082,008, filed Apr. 7, 2011, the contents of which are hereby incorporated by reference in their entirety.

### TECHNICAL FIELD OF THE INVENTION

The present invention relates generally to a social networking communication system. In particular, the present invention relates to controlling social network communications based on geographic criteria.

### BACKGROUND OF THE INVENTION

Social networking is a popular method of staying in contact with social acquaintances. In an increasingly mobile world, social networking can link together old friends who have since moved to different places of the country or world. Members can sign into a social networking website and upload photos of themselves or publish the interests of the member to other members of the social network. Users can also post “status updates” or other public messages that fellow social networkers (commonly referred to as “friends”) can access. Such status updates can serve to publish news articles, political messages, group coupon deals, or simply update the user's friends on events in the user's life.

Many users are inundated by status updates from other friends, sometimes receiving hundreds or even thousands of status updates each day. Many of the status updates are only tangentially relevant to the user and may instead relate to matters that, because of the very nature of social networking, are geographically irrelevant to the user. For example, a user may be subjected to a status update from a friend the user met in high school, when the user lived in rural Virginia, and where the user now lives in Chicago. Such a status update may relate to a news article that the user finds relevant based on the user's experiences in the Virginia hometown. However, other status updates may relate to a coupon for a vendor located in the user's Virginia hometown, which the user is almost certain not to take advantage of.

A status update from the user may also relate to political beliefs of the user that were acquired once the user moved to Chicago, and that are inconsistent with the political beliefs of his Virginia hometown friends. Such a status update may offend the Virginia friends and alienate the user from his high school acquaintances.

A need thus exists for a social networking website or feature on a social networking website that allows a user to limit which friends receive certain communications based on geographic considerations.

### BRIEF SUMMARY OF THE INVENTION

The present application discloses a method and system that allows a user to define a geographic target area to filter certain messages sent within a social network based on geographic criteria. The target area can relate to the user's common shopping area or where the user is likely to be located on a periodic basis, and can allow the user to control which shopping coupons are published to the user. The user can also define the maximum distance he or she is willing to travel for a given event or at a given time. A trip planner is also disclosed that allows a user to specify a planned trip and that alerts other users along a path of the trip.

For example, the present application discloses a method of transmitting a message in a social network having a first user and a plurality of other users, including establishing a target area of the first user; receiving a request to transmit the message from one of the other users; determining a geographic relevance of the message; establishing a point or area corresponding to the geographic relevance of the message; determining whether the target area of the first user at least partially overlaps the point or area corresponding to the geographic relevance of the message; and transmitting the message to the first user if the target area of the first user at least partially overlaps with the point or area corresponding to the geographic relevance of the message.

Also disclosed is a server device for facilitating a transmission of a message in a social network having a first user and a plurality of other users, including a processor; and a computer-readable medium, wherein the computer-readable medium includes instructions executable by the processor and causing the processor to establish a target area of at least some of the other users; receive a request to transmit the message from the first user; determine a geographic relevance of the message; establish a point or area corresponding to the geographic relevance of the message; determine whether the target area of the first user at least partially overlaps with the point or area corresponding to the geographic relevance of the message; and transmit the message to the first user if the target area of the first user at least partially overlaps with the point or area corresponding to the geographic relevance of the message.

In addition, the present application discloses a non-transitory computer-readable medium for use within a system having a first user and a plurality of other users, the computer-readable medium including instructions for establishing a target area of at least some of the other users; instructions for receiving a request to transmit a message from the first user; instructions for determining a geographic relevance of the message; instructions for establishing a point or area corresponding to the geographic relevance of the message; instructions for determining whether the target area of the first user at least partially overlaps with the point or area corresponding to the geographic relevance of the message; and instructions for transmitting the message to the first user if the target area of the first user at least partially overlaps the point or area corresponding to the geographic relevance of the message.

### BRIEF DESCRIPTION OF THE DRAWINGS

For the purpose of facilitating an understanding of the subject matter sought to be protected, there is illustrated in the accompanying drawings embodiments thereof, from an inspection of which, when considered in connection with the following description, the subject matter sought to be protected, its construction and operation, and many of its advantages should be readily understood and appreciated.

FIG. 1 is a schematic diagram of an embodiment of the present invention;

FIG. 2 is a schematic diagram illustrating the hardware components of an embodiment of a user device of the present invention;

FIG. 3 is a flow chart of an embodiment of the present invention depicting a method for communicating via a social networking website;

FIG. 4 is a flow chart of an embodiment of the present invention depicting a method for determining a geographic point of interest of the user;

FIG. 5 is a flow chart of an embodiment of the present invention depicting a method for determining a target area based on the established geographic points of interest of the user;

FIGS. 6(a)-(c) are illustrations of a display showing several geographic points of interest of the user;

FIG. 7(a) is an illustration of a display showing a user-modified target area based on the user-inputted geographic points of interest; and

FIG. 7(b) is an illustration of a display showing a completed custom target area.

### DETAILED DESCRIPTION OF PREFERRED EMBODIMENTS

While the present invention is susceptible of embodiments in many different forms, there is shown in the drawings and will herein be described a preferred embodiment of the invention with the understanding that the present disclosure is to be considered as an exemplification of the principles of the invention and is not intended to limit the broad aspect of the invention to embodiments illustrated.

The present application discloses a method and system that allows a user to define a geographic target area and filter communications based on geographic criteria. The communicated messages can be either a public message to fellow users of a social network, or can be a generalized broadcast from the user relating to an upcoming trip, for example. In an embodiment, the target area can relate to the user's common shopping area or where the user is likely to be located in a given day. The target area can also be dependent on the maximum distance the user is willing to travel for a given event or at a given time.

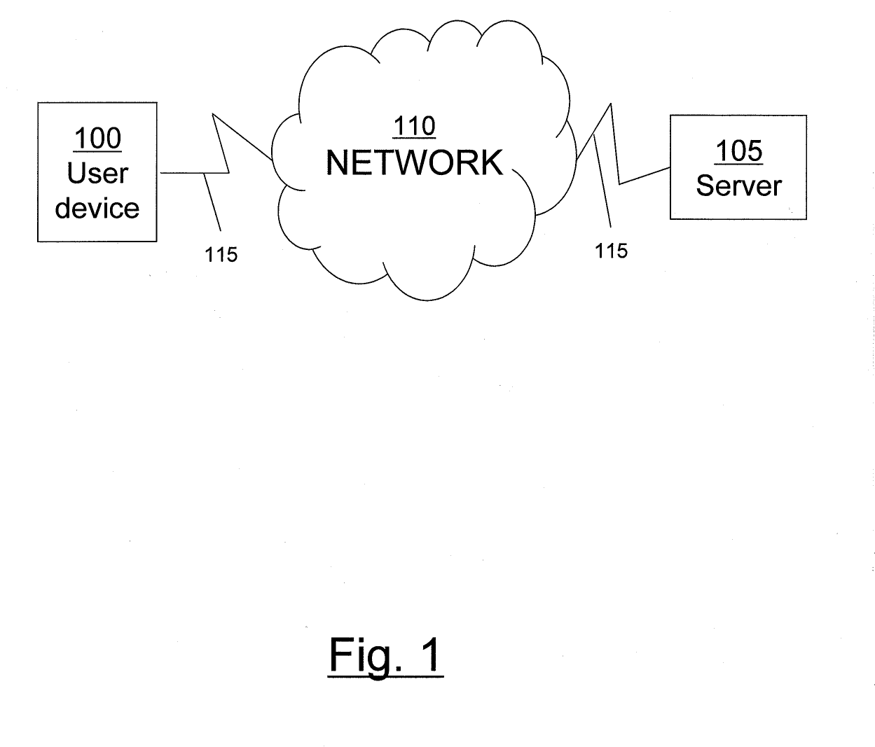

In an embodiment, referring to FIG. 1, a user device 100 may be operably coupled to a server 105 via a network 110 by way of communication links 115, such as, for example, the Internet. The user device 100 communicates with the server 105 to transmit data to and receive data from the server 105. Such data can include, for example, messages or requests to publish messages, travel announcements, search queries from the user, commercial offers received from the server 105 to the user device 100, and data that depicts the geographic points of interest of the user or the target area of the user. Any other relevant data can be transmitted from the user device 100 to the server 105 without departing from the spirit and scope of the present application. In an embodiment, the data includes a message generally broadcast to a social network that includes a commercial offer, such as a link to a group coupon.

As discussed below, based on geographic points of interest of the user, an embodiment of the present invention determines a target area that more closely identifies an area that the user is likely to frequent and conduct business. Accordingly, messages provided over a social network can be more closely tailored to a target consumer audience that is more likely to accept, for example, the commercial offer of the message, or be interested in the content of the message. As used herein, the term “geographic points of interest” can include any geographic point and can be determined either manually by user input or automatically if the user has not input any custom geographic points of interest. By way of example, common geographic points of interest may include the location of the user's home, the location of the user's work, the location of the user's children's school, the location of the user's church, synagogue, mosque, or other place of worship, restaurants or other businesses commonly frequented by the user, or any other location that may help define the routine of the user and/or the locations where the user is likely to do business. It will be understood that the intent is that the preferred geographic points of interest are those points where the user typically travels to and/or from, although any points of interest can be included, such as, for example, a location where the user is going on a vacation, a location with political beliefs similar to or different from the user, or a point located along a travel path of a user during a trip of the user.

The target area can also be imputed without reference to any geographic point of interest, and need not be related to the user's routines. For example, the target area can instead relate to political beliefs, where the user's target area refers to geographic areas commonly associated with liberal or conservative views, for example. The user can thus post messages on a social networking site, for many fellow users to see, and such messages can be broadcast only to those users who are located in geographic areas with political beliefs that correspond to the user's political beliefs. Alternately, the message can be broadcast to the geographic area with political beliefs that do not correspond to the political beliefs of the user, for example, if the user wants to provoke a debate on a political topic. As an example, assume a user has social networking “friends” located in both Chicago and rural Virginia. Based on common social trends, statistically speaking, the people of rural Virginia are more likely to vote for conservative politicians, and the people from Chicago are more likely to vote for liberal politicians. A message posted by the user to all friends, therefore, may offend friends from one of the two geographic areas. However, an embodiment of the present invention allows the user to choose which geographic area to focus the message or otherwise limit the offended audience, or if so chosen, increase the offended audience.

The user device 100 can be a device of any type that allows for the transmission and/or reception of data. By way of example, the user device 100 can include a smart phone (e.g. iPhone®), personal computer, voice and video telephone set, streaming audio and video media player, integrated intelligent digital television receiver, DVS receiver, work station, radio, personal digital assistant (PDA), mobile satellite receiver, GPS receiver, software system, or any combination of the above.

The server 105 can also be a device of any type that allows for the transmission and/or reception of data, and that is adapted to store information to be transmitted to the user device 100. For example, the server 105 can include any device listed above with respect to the user device 100, or can include a non-transitory computer-readable recording medium, such as a hard drive, DVD, CD, flash drive, volatile or non-volatile memory, RAM, or any other type of data storage.

The network 110 may be a single network or a plurality of networks of the same or different type. In an embodiment, the network 110 is the Internet. The term “social network,” as used herein, refers to a website or software program where multiple users can communicate with one another through the Internet or other communication means, such as, for example, Facebook or MySpace.

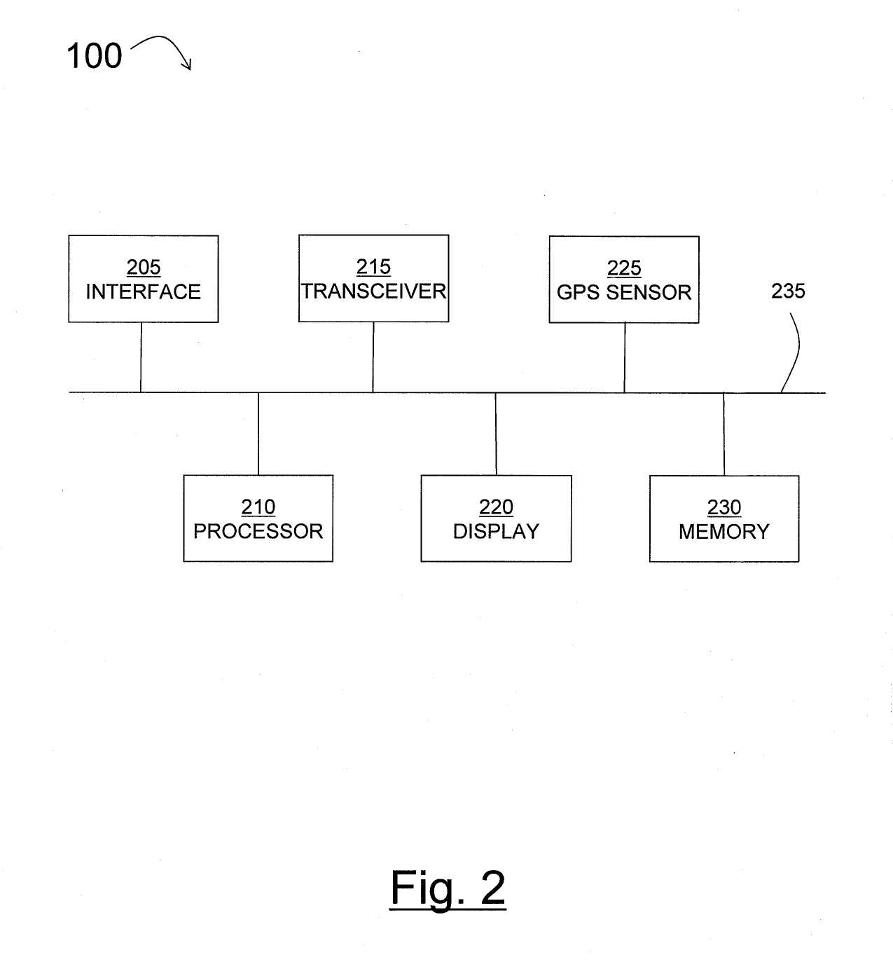

FIG. 2 is a schematic diagram illustrating exemplar hardware components of a user device 100 using an embodiment of the present invention. As shown, the user device 100 can include an interface 205, processor 210, transceiver 215, display 220, GPS sensor 225 and a memory 230 connected via a bus 235.

The interface 205 allows the user to input information or commands into the user device 100 and to transmit the information or command to the server 105 via the network 110. By way of example, the interface can include a keyboard, mouse, touch screen, audio recorder, audio transmitter, member pad, voice-to-text or any other device that allows for the entry of information from a user.

In an embodiment, a GPS sensor 225 is provided and adapted to allow the user device 100 to determine GPS coordinates and thus determine the user's geographic orientation. The GPS coordinates of the user device 100 can be used to determine various geographic points of interest of the user without having to prompt the user to manually input such geographic points of interest.

Similar to the server 105 discussed above, the memory 230 can include any non-transitory computer-readable recording medium, such as a hard drive, DVD, CD, flash drive, volatile or non-volatile memory, RAM, or any other type of data storage.

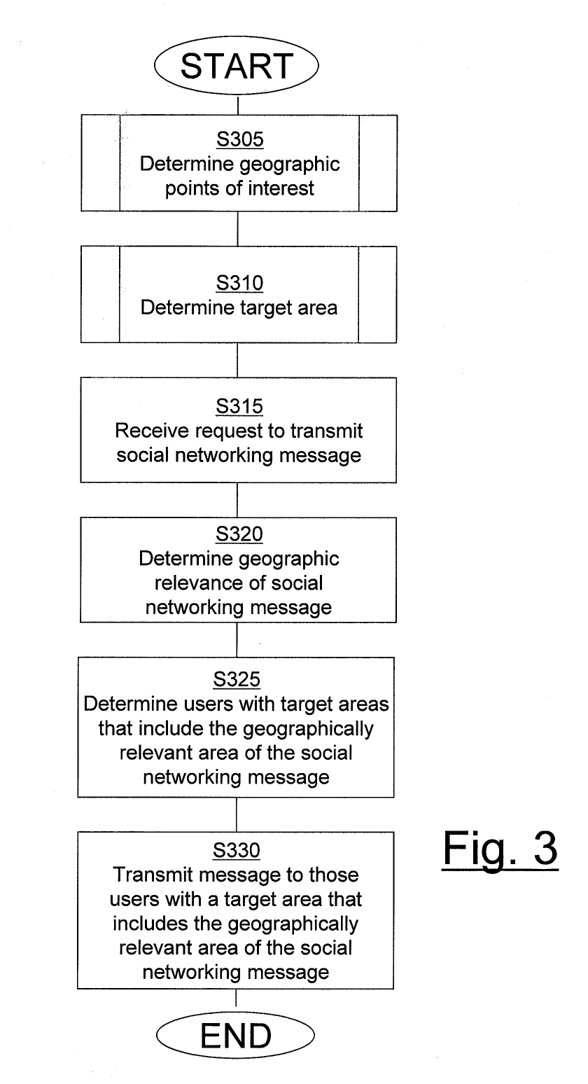

FIG. 3 discloses a flow chart depicting an embodiment of the present invention in which messages are provided to users with target areas that include a geographically relevant area of the message. The process starts at S305, where geographic points of interest are determined by either manually asking the user to input the geographic points of interest or by automatically determining the geographic points of interest based on various factors. As discussed above, in an embodiment, the geographic points of interest represent locations in which the user is likely to travel based on his or her routine and/or based on areas that the user commonly frequents. Alternately, the geographic points of interest can represent locations along a travel path or locations that typically hold certain political beliefs. In some embodiments, the target area can be determined without regard to geographic points of interest of the user.

The process can then proceed to S310, where the target area can be determined. The target area can be an area that depicts where the user frequently is located or travels based on his or her routine in a broader sense than that depicted in S305 with respect to the geographic points of interest. Alternately, the target area can represent an area that the user is likely to travel on a trip or that the user shares a political interest with. As discussed below, the target area may be modified by the user or may be automatically modified by the user device 100 to provide a more narrowly tailored target area for the particular user. For example, the target area can be created when a user modifies a default target area surrounding a geographic point of interest.

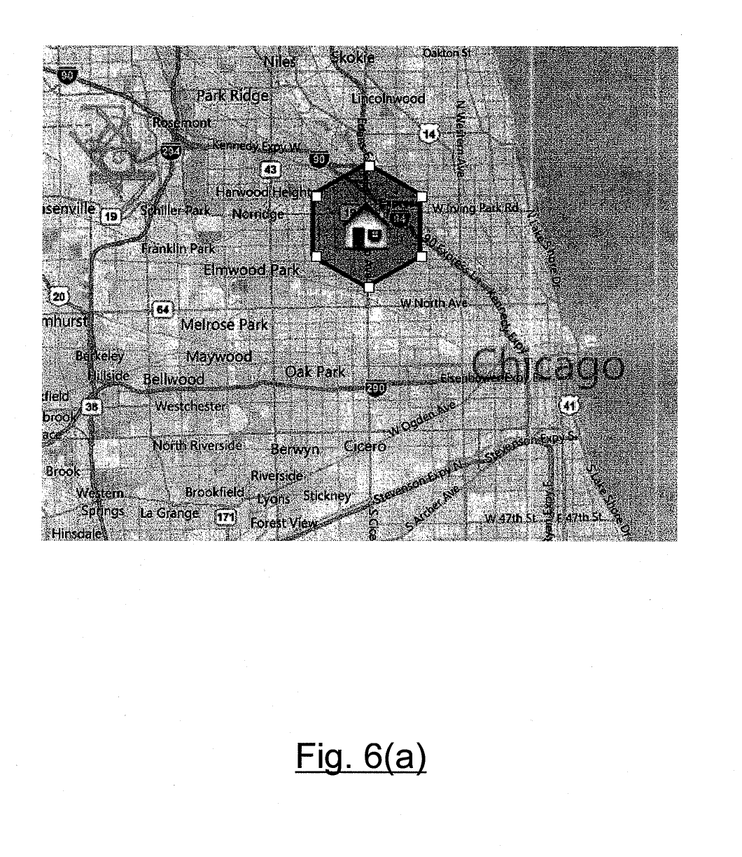

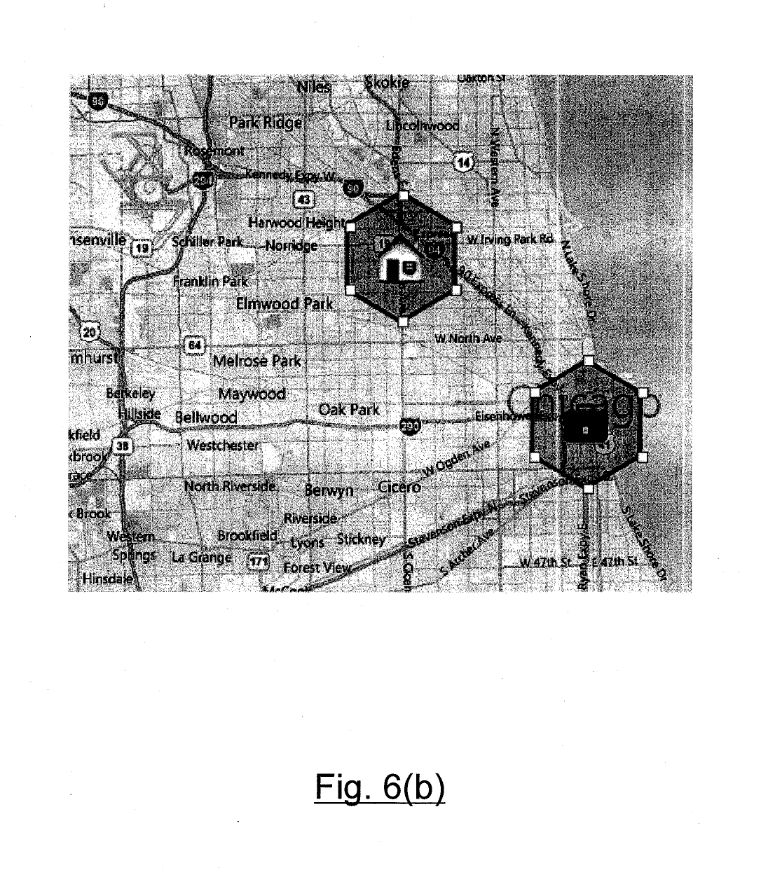

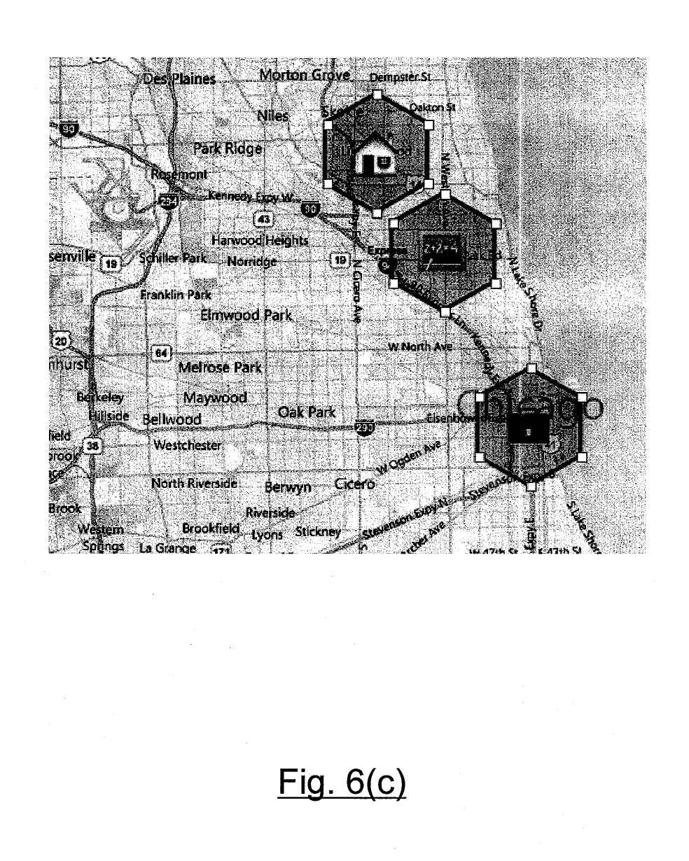

The geographic points of interest can be modified by typical click-and-drag capabilities and can be represented in any shape. Therefore, while the geographic points of interest are shown as hexagonal in FIGS. 6(a)-6(c), it will be appreciated that other shapes can be used, such as, for example, circular, square, rectangular or polygonal. Moreover, the size of the shape can be modified in order to better represent the relevant geographic search area. For example, a circular shape could represent a 5-mile radius from a particular point of interest, wherein vendors within the 5-mile radius would have their commercial offers displayed to the user, and vendors outside of the 5-mile radius would not be displayed since it is unlikely the user would conduct business with that vendor. Also, the target area can include a default radius around which political affiliations are generally the same, statistically speaking. Moreover, the points of interest can further be interconnected to designated preferred travel corridors when the user travels between the different points of interest. For example, the home point of interest can be interconnected with the work point of interest, wherein geographically relevant businesses, users, or political affiliations along the designated travel route may be provided to the user.

The shape of the target area can also be modified based on the user's willingness to travel a certain distance to purchase products from a vendor, to attend an event related to a commercial offer, or for any other reason. For example, a user may choose to increase his or her target area for a concert event, where the user is willing to travel 60 miles or more. The user is also likely to limit their target area for communications related to lunch restaurants, where the user is less likely to be willing to travel a longer distance. The acceptable travel distance can also be determined based on a time of day or day of the week. For example, the user may limit the target area based on a smaller acceptable travel distance during working days, and increase the target area based on a larger acceptable travel distance during weekend days.

Once the target area has been determined in S310, the server 105 may receive a request from a user to transmit a message in S315. The message can either be a “status update,” or a comment provided on a status update, a mass email-type message, a group text message, a group instant message, or any other communication method where a plurality of users are presented with the same or similar message. The content of the message is not limited, and can include a political message, a website link, a link to a group coupon or other commercial offer, a news article, an inspirational quote, content associated with an online game, a music recommendation, or any other form of data that can be displayed or transmitted over a network.

Once the server 105 receives the request to transmit a message, the server can determine the geographic relevance of the message in S320. The geographic relevance can be determined either manually, as input by the user (e.g., inputting that the message is intended for the friends located in rural Virginia rather than Chicago), or automatically, by performing a keyword search to determine the geographic relevance of the message and which areas the message may be applicable to, for example. Any other manner of determining the geographic relevance of the message may be implemented without departing from the spirit and scope of the present invention.

Once the server 105 determines the geographically relevant area of the message, the server 105 then determines which users in the social network include target areas that include the geographically relevant area. For example, if the user requests to send the message to all of his or her “friends,” the server 105 will determine which friends include target areas that correspond to the geographically relevant area of the message. By default, if some of the friends do not have a “target area” as defined within this application, the server 105 may decide to treat such users as having infinite target areas and subject such users to the message regardless of the criteria set forth above. Otherwise, the server 105 can determine whether the user's target area includes the geographically relevant area of the message, e.g., whether the two geographic areas overlap or whether the geographically relevant area is wholly within the user's target area. If the server 105 determines that the two areas overlap or that the geographically relevant area is within the target area, the server 105 may cause the transmission of the message to those users that have a target area including the geographically relevant area in S330.

The above process allows the user to predefine their target area and subject themselves only to messages that are relevant to their geography. For example, using the above method, the user can filter messages from other users relating to coupon deals in areas other than where the user lives or where the user is likely to conduct business. The user can also filter messages relating to different or similar political views based on the geography of the user who originated the message. Moreover, the user can establish a target area and a second user can plan a trip on the social networking website where, if the path of the trip overlaps with the target area of the user, the social networking website can notify the user of such an overlap so that the two parties can meet.

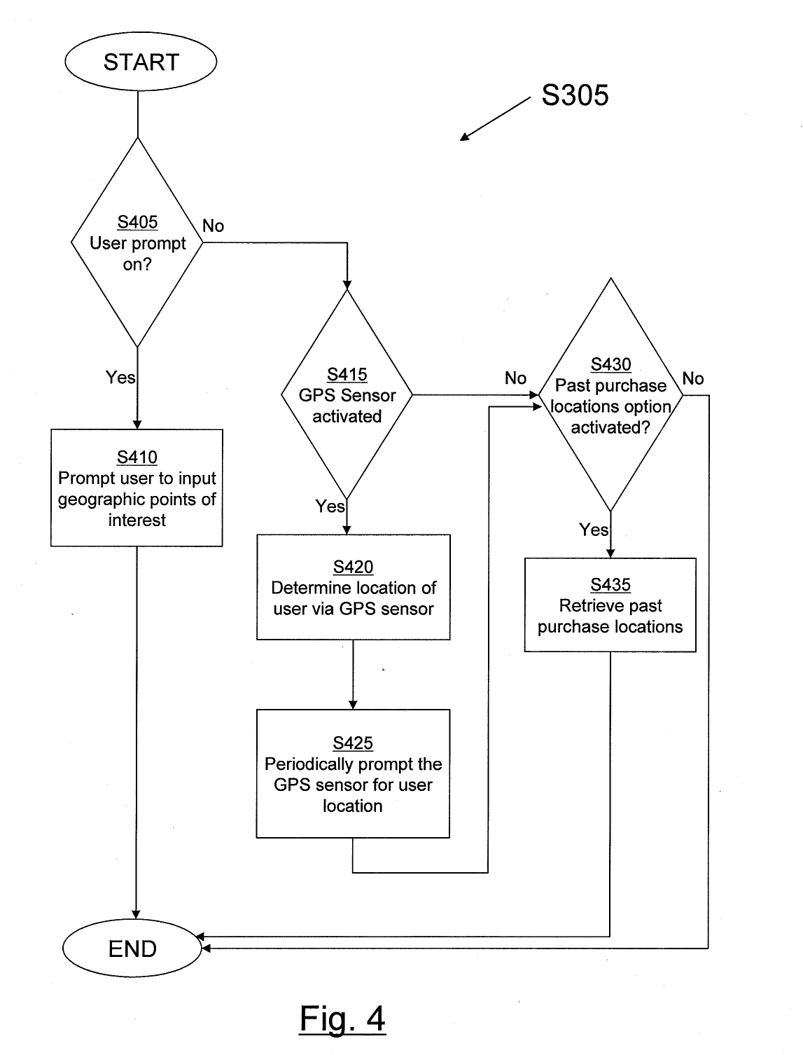

FIG. 4 is a flow chart illustrating a more detailed description of S305, in which geographic points of interest are determined. The process starts at S405, where it is determined whether a user prompt is currently activated. If the user prompt is activated, the process proceeds to S410 where the system prompts the user to input geographic points of interest. For example, the system may prompt the user to input a location of the user's home, the user's work, the location of the user's children's school, or any other locations that the user frequently visits. After the user enters the geographic points of interest, the manually input geographic points of interest are established as the geographic points of interest and the process according to S305 ends.

If the user prompt is not activated, the user device 100 can automatically determine geographic points of interest based on various factors discussed below. Each of these factors may be toggled on or off as desired by the user to provide a more custom-tailored list of geographic points of interest. For example, as shown in FIG. 4, if the user prompt is not on, the process may determine whether the GPS sensor has been activated in S415. If the GPS sensor has been activated, the process may proceed to S420, in which the GPS sensor determines the location of the user. The user location determined in S420 can be established as a geographic point of interest either separate from or in addition to other geographic points of interest established based on other factors. Alternately, or in addition to the above, the server 105 and/or the network 110 can prompt the GPS sensor for the user location, as depicted in S425. Following this process, or if the GPS sensor is not activated, the process proceeds to S430.

In S430, it is determined whether a past purchase locations option has been activated within the user device. In an embodiment, this option is adapted to determine the past locations that the user purchased goods or services under the assumption that a user is more likely to purchase goods or services in locations where he or she previously conducted consumer transactions. If the past purchase locations option is activated, the process proceeds to S435 where the user device 100 retrieves past purchase locations from the server 105, the memory 230, or another storage device within the network 110. For example, the user device 100 may store in the memory 230 various purchase locations manually or automatically input into the memory 230. The user device 100 can also retrieve from the server 105 or another data storage device on the network 110 information from the user's credit card company, bank, or other commercial organization (e.g., PayPal®) to determine the location in which the user purchased items in the past. Once the geographic point of interest has been determined in S435, the process according to S305 ends. Alternately, if the past purchase locations option is not activated, the process according to S305 ends without attempting to retrieve the past purchase locations as depicted in S435.

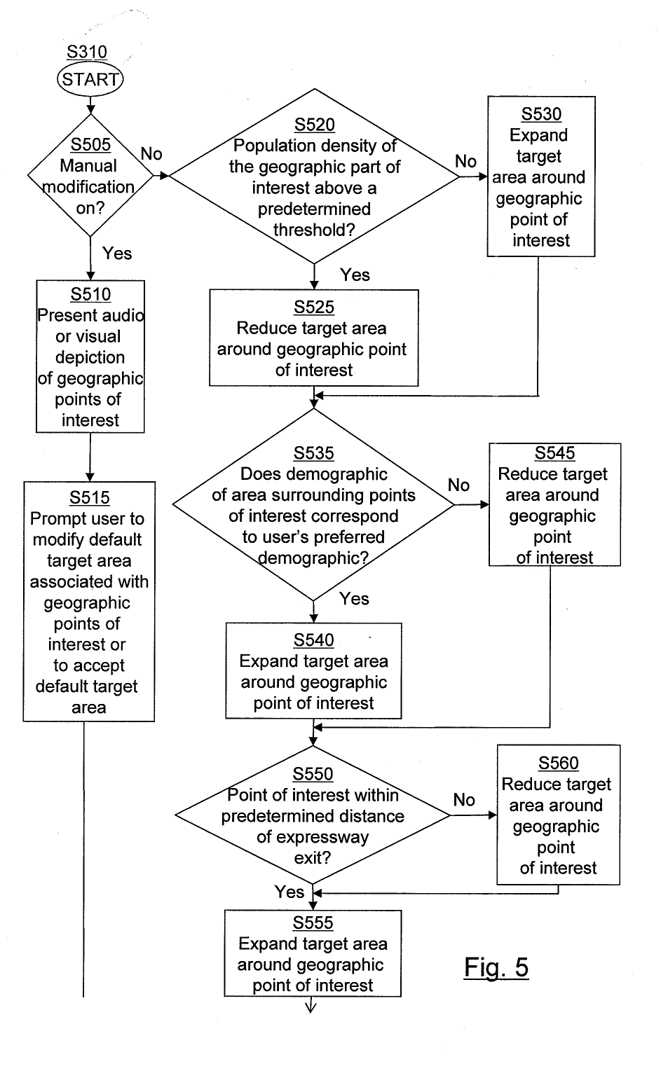

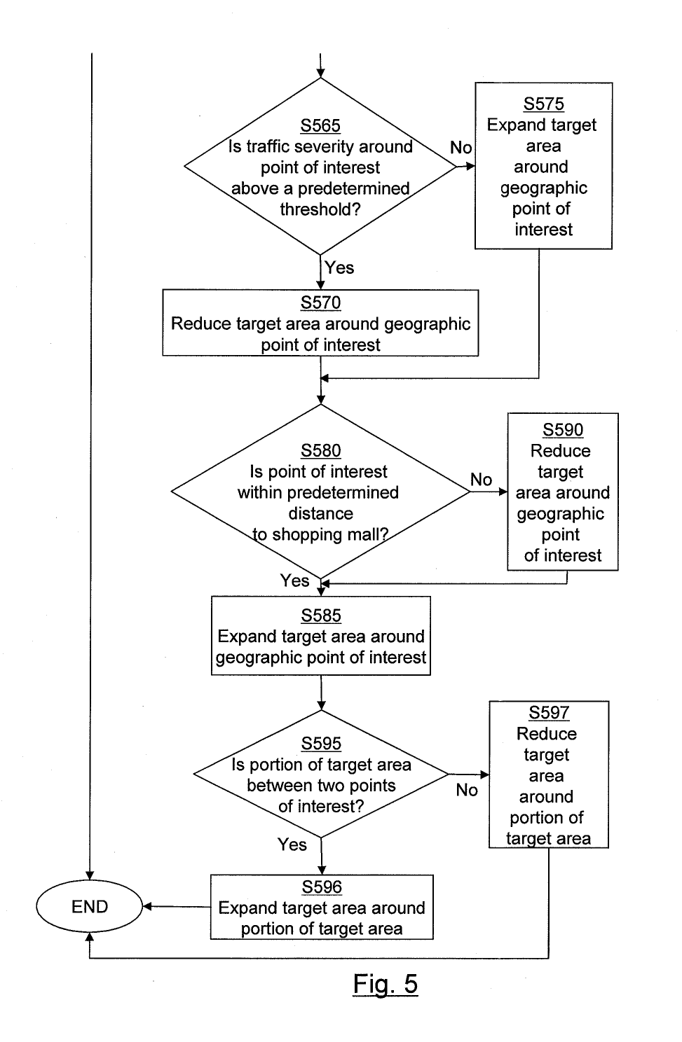

FIG. 5 illustrates a flow chart in which the target area is generated according to S310 based on the geographic points of interest that have been established in S305, as discussed above. In an embodiment, the process begins at S505, where it is determined whether the manual modification option is on. If the manual modification option is on, the process proceeds to S510, where audio and/or visual depictions of the geographic points of interest are presented to the user. For example, the user can view the visual depiction of the geographic points of interest on a map so the user can determine which types of manual modifications are desired to more closely tailor the target area to the user's unique travels and locations. In S515, the user device 100 prompts the user to modify the default target area associated with the geographic points of interest or to accept the default target area without modification. The default target area can include a predetermined radius surrounding the geographic point of interest, e.g., a 3-mile radius surrounding the geographic point of interest. The user can then modify the target area associated with the geographic point of interest or accept the default target area in S515. The user may wish to modify the target area based on any factor considered important to the user, for example, the population density of the geographic point of interest being above a predetermined threshold S520, S525, S530, the demographic of the area surrounding the points of interest S535, S540, S545, whether the geographic point of interest is within a predetermined distance of an expressway or highway exit S550, S555, S560, the traffic severity surrounding the geographic point of interest S565, S570, S575, whether the geographic point of interest is within a predetermined distance to a shopping mall S580, S585, S590, or whether a portion of the target area is between two geographic points of interest S595, S596, S597.

Following either the manual and/or automatic analysis, the process according to S310 is complete and the target area is established for the user. Accordingly, the process according to S310 ends following the manual and/or automatic analysis of the geographic points of interest.

It is noted that many of the above modifications were discussed as being made to geographic points of interest rather than to sections of the target area that are not necessarily geographic points of interest. It should be noted that any of the above manual or automatic modifications can be made either to an established geographic point of interest or a portion of the target area that is not input by the user or determined automatically by the user device 100 to be a geographic point of interest. For example, a specific portion of the target area between the user's home and work can be analyzed to determine whether that specific portion of the target area is above or below the predetermined population density threshold according to S520.

It is also noted that many of the automatic modifications assume that the user will choose either an automatic or manual modification process, but not both. However, it should be noted that the user can have sole discretion to either manually or automatically, or both manually and automatically modify his or her target area depending on factors relevant to his or her routine. In addition, the modifications can be expanded or reduced variably. For example, the user may choose to expand his or her target area by a 1-mile radius if the portion of the target area or geographic point of interest is above the predetermined threshold for the population density in accordance with S520, but may choose to expand or reduce the target area surrounding the geographic point of interest or a portion of the target area by 3 miles if the demographic of that area matches the preferred demographic of the user. It will further be appreciated that the present invention can operate with one or more of the above-described automatic or manual modifications, and not all. Accordingly, each above described automatic or manual modification is optional, exemplary and non-exhaustive.

FIGS. 6(a)-(c) shows a display of a map with specific geographic points of interest chosen manually by a user. As shown in FIG. 6(a), in this example, the user lives in the Chicago metropolitan area, and has manually chosen the Lincolnwood area as the location of his or her home. The process then prompts the user to input the location of his or her place of business, which is in the downtown loop area of Chicago, as shown in FIG. 6(b). The user can then input any other location as a geographic point of interest, e.g., the school of the children of the user, as shown in FIG. 6(c).

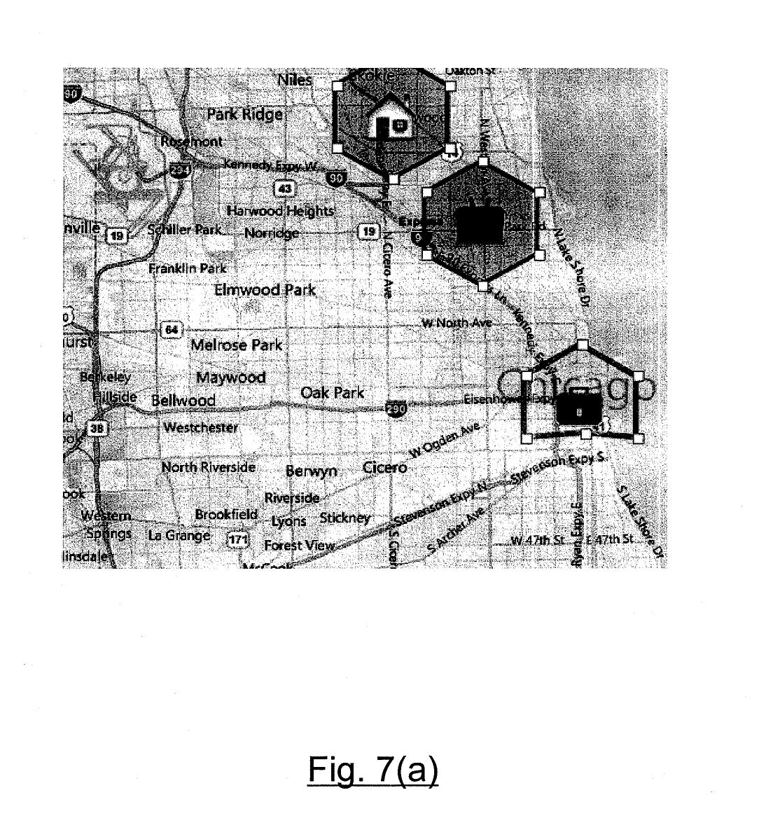

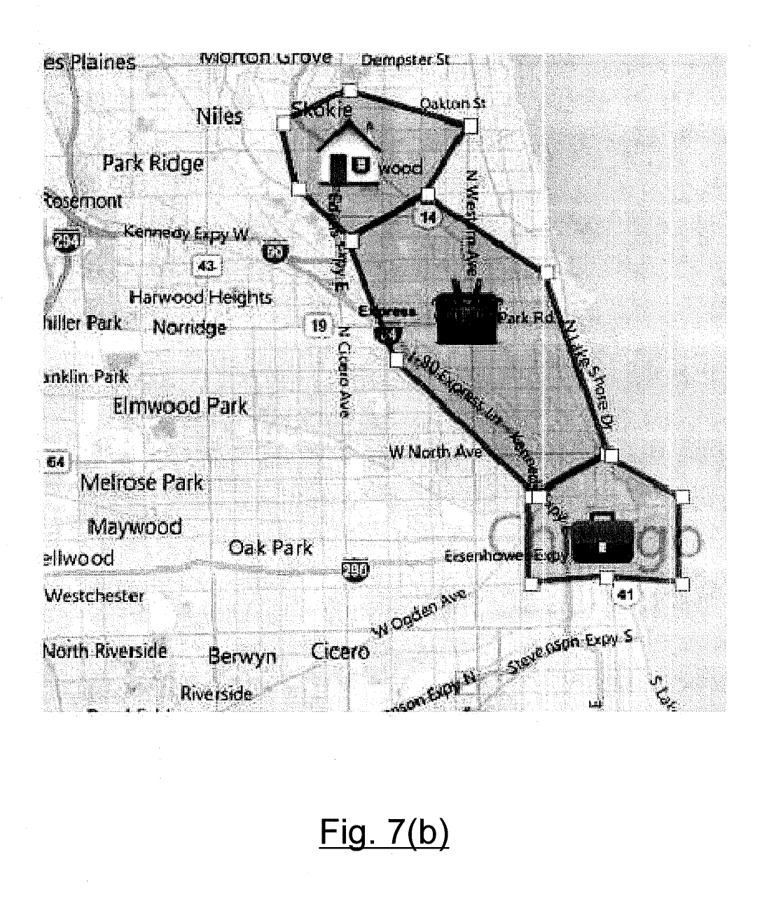

As shown in FIG. 7(a), the user can modify the target area by using an input device (e.g., a computer mouse) and dragging the default radius, shape and/or size on any one of the geographic points of interest. As shown in this example, the user has decided to modify the target area associated with the user's work. The user has decided to shrink the target area surrounding this geographic point of interest to exclude the southern end thereof. Of course, any other modifications, including enlarging and shrinking the target area or modifying the shape, can be performed by the user based on any factor the user deems relevant. As shown in FIG. 7(b), the target areas surrounding the geographic points of interest have merged in accordance with the factors determined in S310 to form a custom target area for the individual user.

It is noted that many of the above examples provide a target area associated with the user's home and work locations, which would generally be located within the same metropolitan area. However, the user may create a separate profile for a separate metropolitan area, e.g., if the user has a vacation home in another metropolitan area. For example, if the user lives in New York, but regularly vacations in Miami, the user may create a separate profile for his or her Miami home with its own set of geographic points of interest and its own target areas. The separate profile can temporarily replace and suspend the original target area or can maintain both of the target areas simultaneously. By suspending the original target area, the user can avoid receiving messages from within his or her regular shopping area while temporarily absent.

The matter set forth in the foregoing description and accompanying drawings and examples is offered by way of illustration only and not as a limitation. More particular embodiments have been shown and described, and it will be apparent to those skilled in the art that changes and modifications may be made without departing from the broader aspects of Applicant's contribution. The actual scope of the protection sought is intended to be defined in the following claims when viewed in their proper prospective based on the prior art.

What is claimed is:

1. A method of transmitting a message in a network having a first user and a second user, comprising:
establishing a target area of the first user;
receiving a request to transmit the message from the second user
determining a geographic relevance of the message;
establishing a point or area corresponding to the geographic relevance of the message;
determining whether the target area of the first user at least partially overlaps the point or area corresponding to the geographic relevance of the message; and
transmitting the message to the first user if the target area of the first user at least partially overlaps the point or area corresponding to the geographic relevance of the message.

2. The method of claim 1, wherein the step of determining the geographic relevance is performed by allowing the second user to manually provide the geographic relevance.

3. The method of claim 1, wherein the target area defines a corridor routinely visited by the first user.

4. The method of claim 1, wherein the target area represents a geographic area with political beliefs that correspond to political beliefs of the first user.

5. The method of claim 1, wherein the target area corresponds to a maximum travel distance the first user is willing to travel.

6. The method of claim 5, wherein the geographic the point or area corresponding to the geographic relevance of the message is based on a planned travel path of the second user.

7. The method of claim 5, wherein the target area is modifiable based on a time and event represented in the message.

8. The method of claim 1, further comprising receiving a command from the first user to modify a shape and size of the target area.

9. A server device for facilitating transmission of a message in a network having a first user and a second user, comprising:
a processor; and
a computer-readable medium, wherein the computer-readable medium includes instructions executable by the processor and causing the processor to:
establish a target area of the first user;
receive a request to transmit the message from the second user;
determine a geographic relevance of the message;
establish a point or area corresponding to the geographic relevance of the message;
determine whether the target area of the first user at least partially overlaps with the point or area corresponding to the geographic relevance of the message; and
transmit the message to the first user if the target area of the first user at least partially overlaps the point or area corresponding to the geographic relevance of the message.

10. The method of claim 9, wherein the instructions for determining the geographic relevance is performed by allowing the second user to manually provide the geographic relevance.

11. The method of claim 9, wherein the target area defines a corridor of locations routinely visited by the first user.

12. The method of claim 9, wherein the target area represents a geographic area with political beliefs that correspond to political beliefs of the first user.

13. The method of claim 9, wherein the target area corresponds to a maximum travel distance the first user is willing to travel.

14. The method of claim 13, wherein the geographic point or area corresponding to the geographic relevance of the message is based on a planned travel path of the second user.

15. The method of claim 13, wherein the target area is modifiable based on a time and event represented in the message.

16. The method of claim 9, wherein the computer-readable medium further includes instructions causing the processor to receive a user command to modify a shape and size of the target area.

17. A non-transitory computer-readable medium for use within a system having a first user and a second user, the computer-readable medium comprising:
instructions for establishing a target area of the first user;
instructions for receiving a request to transmit a message from the second user;
instructions for determining a geographic relevance of the message;
instructions for establishing a point or area corresponding to the geographic relevance of the message;
instructions for determining whether the target area of the first user at least partially overlaps the point or area corresponding to the geographic relevance of the message; and
instructions for transmitting the message to the first user if the target area of the first user at least partially overlaps the point or area corresponding to the geographic relevance of the message.

18. The non-transitory computer-readable medium of claim 17, wherein the target area represents a geographic area with political beliefs that correspond to political beliefs of the first user.

19. The non-transitory computer-readable medium of claim 17, wherein the target area corresponds to a maximum travel distance the first user is willing to travel, and wherein the geographic the point or area corresponding to the geographic relevance of the message is based on a planned travel path of the one of the other users.

20. The non-transitory computer-readable medium of claim 17, wherein the target area is modifiable based on a time and event represented in the message.
